(19) United States
(12) Patent Application Publication
(10) Pub. No.: US 2021/0000155 A1
(43) Pub. Date: Jan. 7, 2021

(54) EDIBLE FIBER

(71) Applicant: SOCIETE DES PRODUITS NESTLE S.A., Vevey (CH)

(72) Inventors: Jan Engmann, Lausanne (CH); Emma Rose Janecek, Lausanne (CH); Veronique Michaud, Sephorin sur Morges (CH); Yunpeng Qu, Ecublens (CH); Federica Sordo, Lausanne (CH); Fabien Sorin, Saint-Sulpice (CH); Francesco Stellacci, Morges (CH); Timothy James Wooster, Epalinges (CH)

(21) Appl. No.: 16/969,424

(22) PCT Filed: Feb. 12, 2019
(86) PCT No.: PCT/EP2019/053360

§ 371 Date: Aug. 12, 2020

(30) Foreign Application Priority Data
Feb. 14, 2018 (EP) 18156715.7

(51) Int. Cl. A23L 33/28; A23P 30/00; A23K 20/147; A23L 29/30; A23J 3/28; A23J 3/06; D01D 5/24; D01D 5/253; D01F 1/10; D01F 9/00; A61K 9/70; A61K 8/02

(52) U.S. Cl. CPC A23L 33/28; A23P 30/00; A23K 20/147; A23L 29/37; A23J 3/28; A23J 3/285; A23V 2002/00; D01D 5/24; D01D 5/253; D01F 1/10; D01F 9/00; A61K 9/70; A61K 8/0204; A23J 3/06

(57) ABSTRACT

The invention provides an edible fiber comprising a biopolymer and a plasticiser; wherein the weight ratio of biopolymer to plasticiser is about 1:0.25 to about 1:3; and wherein the fiber has a diameter of about 0.5 μm to about 1 mm.

### FIELD OF INVENTION

The present invention relates to edible fibers and to processes for making edible fibers.

### BACKGROUND

Edible or food-grade fibers produced from a biopolymer can be added to food, cosmetic, pharmaceutical, veterinary, animal feed, nutraceutical and related products in order to influence physical, nutritional, preservation and gustatory properties of the product, and/or be used in the packaging/coating of the product. In order to achieve this it is desirable to have edible fibers having physical and chemical properties which can be altered to produce a desired effect.

It is known to produce both edible and non-edible fibers from a biopolymer using techniques including electrospinning, solution blowing spinning, wet spinning, gel spinning, dry spinning, and coaxial spinning. However, these techniques are associated with significant drawbacks. By way of example, electrospinning uses a charged starting solution, which requires the use of additional chemicals that are potentially non-food-grade or even toxic. Removal of the additional chemicals adds economic cost to fiber production. Some methods produce extremely thin fibers with diameters in the nanometre range; the safety of such “nano foods” has yet to be fully evaluated. Other methods produce fibers that adhere to each other, leading to the unwanted formation of a film.

Extrusion is widely used in the production of foods such as pasta, cereals, whole wheat, wheat starch, and gelatin. However, extrusion is not suitable for the production of thin fibers, for example fibers having a diameter of 1 mm or less. Furthermore, extrusion requires mixing of all of the material components during the extrusion process, making it difficult to obtain well organised or complex cross sectional architectures.

There is therefore a need for alternative and/or improved edible fibers and processes for the production of such edible fibers.

U.S. Pat. No. 6,416,800 describes the production of an edible sugar glass fiber. However, sugar glass is extremely fragile and hence fibers made using sugar glass are highly prone to breaking during manufacture, handling (e.g. shipping) and processing (e.g. when being mixed into a product matrix), thus making it difficult to use such fibers.

### SUMMARY OF INVENTION

The present invention addresses the above prior art problems by providing an edible fiber, together with a process for producing an edible fiber, as described in the claims.

The inventors have surprisingly found that thermal drawing can be applied to the production of food grade edible fibers, enabling the production of edible fibers with novel and advantageous properties. The inventors have found that a biopolymer and a plasticiser may be combined to provide a preform with rheological properties that enable it to be thermally drawn into a fiber of desired length.

In one aspect, there is provided an edible fiber comprising a biopolymer and a plasticiser; wherein the weight ratio of biopolymer to plasticiser is about 1:0.25 to about 1:3; and wherein the fiber has a diameter of about 0.5 μm to about 1 mm.

In one embodiment, the fiber has an aspect ratio of at least about 10.

In one embodiment, the biopolymer comprises (or consists of) a protein and/or a polysaccharide.

In one embodiment, the biopolymer comprises (or consists of) gelatin, casein, egg white albumin, soy protein, whey protein, wheat gluten, pea protein, sorghum kafirin, or millet prolamin.

In one embodiment, the biopolymer comprises (or consists of) gelatin.

In one embodiment, the biopolymer comprises (or consists of) pectin, alginate, or agar.

In one embodiment, the plasticiser comprises (or consists of) a polyol.

In one embodiment, the polyol is glycerol, sorbitol, glucose, sucrose, maltitol, xylitol, erythritol, or isomalt.

In one embodiment, the fiber comprises at least one hollow channel.

In another aspect, there is provided a process for producing an edible fiber as described above, the process comprising the steps of: (a) combining a biopolymer and a plasticiser in a weight ratio of biopolymer to plasticiser of about 1:0.25 to about 1:3 to produce a preform; (b) subjecting the preform to thermal drawing to produce an edible fiber.

In one embodiment, thermal drawing is carried out at a drawing temperature of about 30° C. to about 300° C.

In one embodiment, the biopolymer comprises (or consists of) a protein and/or a polysaccharide.

In one embodiment, the biopolymer comprises (or consists of) gelatin, casein, egg white albumin, soy protein, whey protein, wheat gluten, pea protein, sorghum kafirin, or millet prolamin.

In one embodiment, the biopolymer comprises (or consists of) gelatin.

In one embodiment, the biopolymer comprises (or consists of) pectin, alginate, or agar.

In one embodiment, the plasticiser comprises (or consists of) a polyol.

In one embodiment, the polyol is glycerol, sorbitol, glucose, sucrose, maltitol, xylitol, erythritol, or isomalt.

In another aspect, there is provided an edible fiber obtainable by the process of the invention.

In another aspect, there is provided a solution or gel comprising an edible fiber of the invention.

In one embodiment, the solution or gel is an oil based solution or gel.

In one embodiment, the solution or gel is an aqueous solution or gel.

In a further aspect, there is provided a food, cosmetic, pharmaceutical, veterinary, animal feed or nutraceutical product comprising an edible fiber of the invention.

In a further aspect, there is provided a packaging or coating material comprising an edible fiber of the invention.

### DESCRIPTION OF FIGURES

FIG. 1: Rheological curve of gelatin (280 Bloom): glycerol 1:1 preform highlighting G′-G″ cross-over point and the favourable drawing region.

FIG. 2: Rheological curve of gelatin (160 Bloom): glycerol 1:1 preform.

FIG. 3: Rheological curve of gelatin (160 Bloom): glycerol 1:0.5 preform.

FIG. 4: Rheological curve of gelatin (160 Bloom): glycerol 1:0.75 preform.

FIG. 5: Rheological curve of gelatin (280 Bloom): D-sorbitol 1:1 preform.

FIG. 6: Rheological curve of casein: glycerol 2:1 preform.

FIG. 7: (a) Picture of the preform of gelatin (280 Bloom):glycerol 1:1; (b) preform attached to the preform holder; (c) start of the drawing process with reduction in preform diameter; (d) process stabilised, fiber attached to the capstan in order to pull it with a constant speed.

FIG. 8: Optical microscope images of gelatin (280 Bloom):glycerol 1:1 fibers at different fiber location showing the various diameters achieved: (a) 200 μm; (b) 500 μm; (c) hollow core 1000 μm, with 500 μm core diameter.

FIG. 9A: Schematic of thermal drawing process.

FIG. 9B: Thermally drawn gelatin fibers.

FIG. 10: (a) solid core gelatin fiber; (b) hollow core gelatin fiber; (c) multichannel hollow gelatin fiber; (d) square hollow core gelatin preform.

FIG. 11: (a) Optical microscope image of a SEBS-textured gelatin fiber; (b) SEM image of the resulting textured gelatin fiber after SEBS solubilisation. (SEBS—Styrene Ethylene Styrene Block Co-polymer).

### DETAILED DESCRIPTION OF INVENTION

The present invention provides an edible fiber comprising a biopolymer and a plasticiser; wherein the ratio of biopolymer to plasticiser is about 1:0.25 to about 1:3; and wherein the fiber has a diameter of about 0.5 μm to about 1 mm.

As used herein, “about” is understood to refer to numbers in a range of numerals, for example the range of −30% to +30% of the referenced number, or −20% to +20% of the referenced number, or −10% to +10% of the referenced number, or −5% to +5% of the referenced number, or −1% to +1% of the referenced number. All numerical ranges herein should be understood to include all integers, whole or fractions, within the range. Moreover, these numerical ranges should be construed as providing support for a claim directed to any number or subset of numbers in that range.

Also provided are processes for preparing an edible fiber of the invention, together with products comprising an edible fiber of the invention.

The inventors have found that edible fibers having a diameter in the range of about 0.5 μm to about 1 mm may be prepared by thermal drawing of a fiber preform comprising a biopolymer and a plasticiser in a weight ratio (biopolymer:plasticiser) of about 1:0.25 to about 1:3.

Thus, the edible fiber of the invention is obtainable by thermal drawing.

In order for successful thermal drawing of a fiber to take place, the rheological properties of the preform material must allow it to form a highly viscous state in which it flows but does not drip at the drawing temperature. Furthermore, it must be possible to draw the fiber without breaking it, and for the fiber to be cooled from the drawing temperature without collapsing.

Without wishing to be bound by theory, the inventors believe that in order to obtain optimal thermal drawing of an edible fiber formed from a biopolymer, the materials used should preferably satisfy the following rheological requirements: i) a transition from an elastically dominated domain to a viscous dominated one, characterised by a G′-G″ cross-over in a shear viscosity measurement where G′ drops more rapidly with temperature than G″; ii) the complex viscosity values about 1-30° C. above such cross-over are greater than about 10³ Pa*s.

The inventors have found that combining a biopolymer and a plasticiser in the range of weight ratios described above provides a preform with rheological properties that enable it to be thermally drawn into a fiber of desired dimensions.

The biopolymer provides structural support to the fiber, with the plasticiser combining with the biopolymer to tailor the rheological properties to enable thermal drawing of the fiber preform.

The edible fibers of the invention have multiple applications, for example they can be used to effect controlled nutrient release in foods, and also to influence the rheology and texture of food matrices in advantageous ways, for example by increasing the viscosity of a food matrix. Changes in the shape and microstructure of the fibers can be used to influence the rheology of fiber suspensions, such as in a food product, providing new and desirable textures. Furthermore the addition of fibers to a more solid like matrix (such as chocolate) can enhance their mechanical properties (strength fracture behaviour). In the case of packaging materials for food contact, it might be particularly advantageous to have such fibre reinforcement being food grade and/or biodegradable.

The fibers of the invention are edible, meaning that all of the components of the fibers are safe and suitable for consumption by humans and/or animals.

As used herein, the term “biopolymer” refers to a biological polymer. Examples of biopolymers suitable for use in the present invention include proteins and polysaccharides. As used herein, the term “protein” is intended to cover proteins, polypeptides, peptides, and mixtures thereof. In one embodiment, the biopolymer is a protein biopolymer. Thus, in one embodiment, the biopolymer is a protein.

The biopolymer may be an open polymorphic biopolymer, for example an open polymorphic protein. Open polymorphic biopolymers are capable of forming chains that can interact with one another, and are thus capable of forming a structural component of a fiber. Open polymorphic biopolymers may be contrasted to biopolymers that arrange into globular forms, such as a globular protein. Thus, in one embodiment, the biopolymer is not a globular protein.

Examples of protein biopolymers suitable for use in the present invention include gelatin, casein, egg white albumin, soy protein, whey protein, wheat gluten, pea protein, sorghum kafirin, and millet prolamin.

In one embodiment, the biopolymer is gelatin or casein.

In one embodiment, the biopolymer is gelatin.

Gelatin is a well known material used in food science and cooking. Gelatin may be formed by partial hydrolysis of animal collagen. The concentration of gelatin in a gelatin gel influences its properties such as strength. The strength of a gelatin gel may be assessed using the Bloom test, enabling gelatin to be categorised according to Bloom value. The Bloom value provides an indication of the force required to compress the surface of the gelatin without breaking it; a higher value indicates a higher strength gel.

In one embodiment, the biopolymer is a polysaccharide. Examples of polysaccharides suitable for use in the present invention include pectin, alginate, inulin and agar.

The term “plasticiser” refers to a compound which when combined with a biopolymer acts to alter the biopolymer's plasticity and/or viscosity. The greater the proportion of plasticiser in the fiber, the greater the fiber's flexibility.

Examples of plasticisers suitable for use in the present invention include polyols.

In one embodiment, the plasticiser is a polyol.

The term “polyol” as used herein refers to organic compounds that comprise multiple hydroxyl groups. Examples of polyols suitable for use in the present invention include glycerol, sorbitol, glucose, sucrose, maltitol, xylitol, erythritol, or isomalt.

In one embodiment, the polyol is glycerol.

In one embodiment wherein the biopolymer comprises (or consists of) gelatin, the plasticiser comprises (or consists of) glycerol.

In one embodiment wherein the biopolymer comprises (or consists of) casein, the plasticiser comprises (or consists of) glycerol.

In one embodiment, the polyol is sorbitol.

In one embodiment wherein the biopolymer comprises (or consists of) gelatin, the plasticiser comprises (or consists of) sorbitol.

In one embodiment wherein the biopolymer comprises (or consists of) casein, the plasticiser comprises (or consists of) sorbitol.

The weight ratio of biopolymer to plasticiser in the edible fiber of the present invention is preferably from about 1:0.25 to about 1:3; for example from about 1:0.25 to about 1:2.5, from about 1:0.5 to about 1:3, from about 1:0.5 to about 1:2.5, from about 1:0.5 to about 1:2, from about 1:0.5 to about 1:1.5, or from about 1:0.5 to about 1:1; or about 1:0.25, about 1:0.5, about 1:0.75, or about 1:1.

In one embodiment, the weight ratio of biopolymer to plasticiser is from about 1:0.5 to about 1:3.

In one embodiment, the weight ratio of biopolymer to plasticiser is from about 1:0.5 to about 1:2.

In one embodiment, the weight ratio of biopolymer to plasticiser is from about 1:0.5 to about 1:1; for example about 1:0.5, about 1:0.75, or about 1:1.

In one embodiment wherein the biopolymer comprises (or consists of) gelatin, the weight ratio of biopolymer to plasticiser is from about 1:0.5 to about 1:1; for example about 1:0.5, about 1:0.75, or about 1:1.

In one embodiment wherein the biopolymer comprises (or consists of) casein, the weight ratio of biopolymer to plasticiser is from about 1:0.5 to about 1:1; for example about 1:0.5, about 1:0.75, or about 1:1.

The edible fiber of the invention may comprise water. By way of example, the edible fiber may comprise up to about 10 wt. % water, for example, up to about 1 wt. %, about 2 wt. %, about 3 wt. %, about 4 wt. %, about 5 wt. %, about 6 wt. %, about 7 wt. %, about 8 wt. %, about 9 wt. % or about 10 wt. %. The edible fiber may comprise about 1 wt. % to about 10 wt. % water. The edible fiber may comprise less than about 1 wt. % water, or less than about 0.5 wt. % water.

The edible fiber of the invention may have a density greater than 1 g/cm³ (e.g. greater than 2, 3, 4 or 5 g/cm³). The edible fiber may have a density greater than 1 g/cm³ to about 5 g/cm³, for example about 2 g/cm³ to about 5 g/cm³, or about 2 g/cm³ to about 4 g/cm³. The density of the fiber refers to the density of the material forming the substance of the fiber itself, and thus does not for example take into account any hollow spaces that may exist within a fiber structure.

The edible fiber of the invention has a diameter of about 0.5 μm to about 1 mm. By way of example, the edible fiber may have a diameter of about 1 μm to about 1 mm, about 5 μm to about 1 mm, about 10 μm to about 1 mm, about 20 μm to about 1 mm, about 30 μm to about 1 mm, about 40 μm to about 1 mm, about 50 μm to about 1 mm, about 60 μm to about 1 mm, about 70 μm to about 1 mm, about 80 μm to about 1 mm, about 90 μm to about 1 mm, or about 100 μm to about 1 mm. The edible fiber may have a diameter of about 0.5 μm to about 500 μm, about 1 μm to about 500 μm, about 5 μm to about 500 μm, about 10 μm to about 500 μm, about 20 μm to about 500 μm, about 30 μm to about 500 μm, about 40 μm to about 500 μm, about 50 μm to about 500 μm, about 60 μm to about 500 μm, about 70 μm to about 500 μm, about 80 μm to about 500 μm, about 90 μm to about 500 μm, or about 100 μm to about 500 μm. In one embodiment, the edible fiber of the invention has a diameter of about 60 μm to about 500 μm.

Methods for determining the diameter of a fiber are known in the art and would be familiar to a skilled person. Methods for determining the diameter of a fiber include (but are not restricted to) measurement of the diameter using microscopy, for example scanning electron microscopy, confocal laser scanning microscopy, or atomic force microscopy. Protocols for such techniques are well known in the art and would be familiar to a skilled person.

The diameter of a fiber may be defined as the length (e.g. the average length) of a straight line segment that passes through the centre of the fiber cross section and which lies perpendicular to the fiber's longest dimension.

The edible fiber may have an aspect ratio (the ratio of fiber length to fiber diameter) of at least about 10; for example at least about 15, 20, 25, 50, 100, 250, 500, 1000, 10,000, or 100,000. The edible fiber may have an aspect ratio of about 10 to about 1000, or about 10 to about 10,000, or about 10 to about 100,000.

The invention allows for edible fibers with a variety of different architectures to be provided, for example produced by the process of the invention as described below.

The cross sectional shape of the fiber may be varied. By way of example, an edible fiber of the invention may have a cross section that is substantially round, e.g. substantially circular, substantially elliptical, or substantially oval. Alternatively, an edible fiber of the invention may have a cross section that is substantially rectangular, e.g. substantially square or substantially rectangular. Other cross sectional shapes may also be used, for example a cross section that is substantially star-shaped (having the shape of a star polygon, e.g. comprising 5, 6, 7 or more points). The choice of fiber cross sectional shape may be used to alter the fiber surface area for a given diameter.

Different fiber cross sections may be obtained by drawing the fiber from a preform having the desired cross sectional shape, for example by the process of the invention as described herein.

The edible fiber of the invention may be solid. Alternatively, the edible fiber of the invention may be hollow. A hollow edible fiber may comprise one or more hollow channels within the fiber.

Hollow edible fibers may be produced from a hollow preform, such as according to the process of the invention as described herein. A hollow fiber may comprise one or more substances (e.g. a liquid, a gas or a solid) entrapped within it (i.e. entrapped within a hollow portion of the fiber, e.g. a hollow channel), for example a nutrient substance, a sugar, a lipid (e.g. an oil, or medium chain triglycerides), or a protein, either in liquid or solid form. By way of further example, a hollow fiber may comprise entrapped within it an agent such as a flavouring agent. In this way, an edible fiber of the invention can be used to impart properties such as flavour when added to a food product. Entrapping a substance within a hollow fiber, which is then added to a product (e.g. a food product), can be used, for example, to provide a controlled release of the substance as it diffuses and/or dissolves from the hollow fiber into the surrounding product matrix.

For a hollow edible fiber, the ratio of the external diameter of the fiber to the diameter of a hollow channel within the fiber may be from about 100:1 to about 1.2:1, or at least about 1.2:1, at least about 2:1, at least about 5:1, about least about 10:1, at least about 20:1, at least about 50:1, or at least about 100:1.

The cross sectional shape of the hollow section of the fiber may also be varied, in a manner analogous to the fiber cross section as described above. The hollow section of the fiber may have a cross sectional shape such as described above with regard to the cross sectional shape of the fiber itself.

A hollow fiber may comprise a hollow channel inside the fiber running along the fiber's length. A hollow channel may run along at least part of the length of the fiber. A hollow channel may run along substantially the entire length of the fiber. A hollow fiber may comprise more than one hollow channel, for example a hollow fiber may comprise two separate hollow channels running in parallel. A hollow fiber may comprise at least one, at least two, at least three, or at least four hollow channels. A hollow channel may comprise one or more substances (e.g. a liquid, a gas or a solid) entrapped within it. Where a hollow fiber comprises more than one hollow channel, each hollow channel may comprise a different substance entrapped within it.

The edible fiber of the invention may comprise one or more substances adsorbed to a surface of the fiber, for example a sugar (e.g. glucose, fructose or sucrose), a lipid, a protein, or a flavouring agent. A substance may be adsorbed to an external surface of the fiber. Where the fiber is a hollow fiber, a substance may be adsorbed to an internal surface of the fiber (i.e. a surface within the hollow section of the fiber).

The edible fiber of the invention may comprise a textured surface.

Edible fibers of the invention may be combined together, e.g. woven together, to form a mesh or scaffold structure. Such a mesh or scaffold may be used to form a substrate which may be added to a food product. A mesh or scaffold structure formed from edible fibers of the invention may also, for example, be used as a substrate on which cells may be seeded and grown, for example in the production of a food such as a meat-like product.

The present invention also provides a process for producing an edible fiber, the process comprising the steps of: (a) combining a biopolymer and a plasticiser to produce a preform; and (b) subjecting the preform to thermal drawing to produce an edible fiber.

In one embodiment, the biopolymer comprises (or consists of) a protein and/or a polysaccharide.

In one embodiment, the biopolymer comprises (or consists of) gelatin, casein, egg white albumin, soy protein, whey protein, wheat gluten, pea protein, sorghum kafirin, or millet prolamin.

In one embodiment, the biopolymer comprises (or consists of) gelatin.

In one embodiment, the biopolymer comprises (or consists of) casein.

In one embodiment, the biopolymer comprises (or consists of) pectin, alginate, or agar.

In one embodiment, the plasticiser comprises (or consists of) a polyol.

In one embodiment, the polyol is glycerol, sorbitol, glucose, sucrose, maltitol, xylitol, erythritol, or isomalt.

In one embodiment, the polyol is glycerol.

In one embodiment wherein the biopolymer comprises (or consists of) gelatin, the plasticiser comprises (or consists of) glycerol.

In one embodiment wherein the biopolymer comprises (or consists of) casein, the plasticiser comprises (or consists of) glycerol.

In one embodiment, the polyol is sorbitol.

In one embodiment wherein the biopolymer comprises (or consists of) gelatin, the plasticiser comprises (or consists of) sorbitol.

In one embodiment wherein the biopolymer comprises (or consists of) casein, the plasticiser comprises (or consists of) sorbitol.

In one embodiment wherein the biopolymer comprises (or consists of) gelatin, the gelatin has a Bloom value of about 50 to about 300, about 100 to about 300, about 150 to about 290, or about 160 to about 280. In one embodiment, the gelatin has a Bloom value of about 50, about 100, about 150, about 160, about 170, about 180, about 190, about 200, about 210, about 220, about 230, about 240, about 250, about 260, about 270, about 280, about 290 or about 300. In a further embodiment, the gelatin has a Bloom value of 160, 240 or 280.

In one embodiment, the gelatin has a Bloom value of about 160. In one embodiment, the gelatin has a Bloom value of about 240. In one embodiment, the gelatin has a Bloom value of about 280.

In one embodiment, the biopolymer and the plasticiser are combined in a weight ratio of biopolymer to plasticiser of about 1:0.25 to about 1:3; for example from about 1:0.25 to about 1:2.5, from about 1:0.5 to about 1:3, from about 1:0.5 to about 1:2.5, from about 1:0.5 to about 1:2, from about 1:0.5 to about 1:1.5, or from about 1:0.5 to about 1:1; or about 1:0.25, about 1:0.5, about 1:0.75, or about 1:1.

In one embodiment, the weight ratio of biopolymer to plasticiser is from about 1:0.5 to about 1:3.

In one embodiment, the weight ratio of biopolymer to plasticiser is from about 1:0.5 to about 1:2.

In one embodiment, the weight ratio of biopolymer to plasticiser is from about 1:0.5 to about 1:1; for example about 1:0.5, about 1:0.75 or about 1:1.

In one embodiment wherein the biopolymer comprises (or consists of) gelatin, the weight ratio of biopolymer to plasticiser is from about 1:0.5 to about 1:1; for example about 1:0.5, about 1:0.75, or about 1:1.

In one embodiment, the biopolymer comprises (or consists of) gelatin, the plasticiser comprises (or consists of) glycerol, wherein the biopolymer and the plasticiser are combined in a weight ratio of biopolymer to plasticiser of about 1:0.25 to about 1:1, and wherein the gelatin has a Bloom value of about 160.

In one embodiment wherein the biopolymer comprises (or consists of) casein, the weight ratio of biopolymer to plasticiser is from about 1:0.5 to about 1:1; for example about 1:0.5, about 1:0.75, or about 1:1.

In one embodiment, step (a) of the process further comprises heating the biopolymer and the plasticiser. The biopolymer and the plasticiser may be heated at a temperature of about 50° C. to about 90° C., for example about 50° C., about 60° C., about 70° C., about 80° C. or about 90° C.

In one embodiment, the biopolymer and the plasticiser are combined with water, for example to form an aqueous solution of the biopolymer and plasticiser. The water may be present at a weight ratio of biopolymer to water of about 1:5 to about 1:20, e.g. about 1:10. The solution may be cast and dried.

The biopolymer and the plasticiser may be combined in the absence of water. By way of example, the biopolymer may directly absorb the plasticiser. Optionally, heating may be applied to facilitate absorption of the plasticiser by the biopolymer, for example at a temperature of about 50° C. to about 90° C., for example about 50° C., about 60° C., about 70° C., about 80° C. or about 90° C. The combined biopolymer and plasticiser may be cast.

A preform may be produced directly from the casting process. Alternatively, a preform may be produced by hot-pressing of the material. Hot-pressing may comprise one or more hot-pressing steps. Hot-pressing may be used to produce a preform when the biopolymer and the plasticiser are combined in the absence of water.

A hot-pressing process may be performed for between about 10 and about 60 minutes (e.g. about 10, 20, 30, 40, 50 or 60 minutes). A hot-pressing process may be performed at a temperature of about 70° C. to about 120° C. (e.g. about 70° C., about 80° C., about 90° C., about 100° C., about 110° C. or about 120° C.). A hot-pressing process may be performed at a pressure of about 20 to about 40 N/cm² (e.g. about 20, about 30 or about 40 N/cm²).

The preform may be produced from a single combination of biopolymer and plasticiser. Alternatively, the preform may be produced by combining together two or more different components, each of which is formed from a combination of biopolymer and plasticiser. Two or more components may be combined by hot-pressing, such as described above, to produce a preform.

The preform is then subjected to thermal drawing to produce an edible fiber.

Processes for producing non-edible fibers using thermal drawing are known, for example in the manufacture of optical fibers. In a thermal drawing process, a preform may be heated and a fiber drawn out. The process may take place using a drawing tower, which comprises a vertical tube furnace which heats the preform.

In a thermal drawing process, fiber diameter may be controlled by altering the downfeed speed (the speed at which the preform is brought down inside the furnace) and the drawing speed (the speed at which the fiber is drawn from the preform). Following the law of conservation of mass, the draw down ratio (the ratio of the preform diameter to the fiber diameter) is given by the square root of the ratio of these speeds.

In an example thermal drawing process, a heated preform initially deforms under its own weight (or optionally via an added weight) to provide the initial portion of a fiber which may be attached to a pulling device such as a capstan. The pulling device is subsequently used to control the speed at which the fiber is drawn from the preform.

In the process of the invention, the step of thermal drawing may be carried out at a drawing temperature of about 30° C. to about 300° C., for example, about 50° C. to about 300° C., about 50° C. to about 250° C., about 100° C. to about 250° C., or about 150° C. to about 250° C.; or about 30° C., about 40° C., about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., about 200° C., about 210° C., about 220° C., about 230° C., about 240° C., about 250° C., about 260° C., about 270° C., about 280° C., about 290° C., or about 300° C.

In one embodiment, the step of thermal drawing may be carried out at a drawing temperature of about 50° C. to about 150° C. In one embodiment, the step of thermal drawing may be carried out at a drawing temperature of about 150° C. to about 220° C.

As used herein, the term “drawing temperature” may refer to the temperature at the point at which the fiber is drawn from the preform.

The edible polymer to be drawn can also be encapsulated in another material serving as a highly viscous cladding. In such a configuration, the rheological requirements are lifted and the material can be drawn as long as it can flow with viscosity as low as 1 Pa·s. The cladding can be removed post-drawing by various methods including mechanical removal or dissolution.

Edible fibers of the invention may be added to food, cosmetic, pharmaceutical, veterinary, animal feed, nutraceutical, and related products, and/or be used in the packaging/coating of said products.

Edible fibers of the invention may be added to a solution or gel, to form a solution or gel comprising an edible fiber of the invention. The solution or gel may be oil based. The solution or gel may be aqueous. Such a solution or gel may subsequently in turn be added to a food product, cosmetic product or pharmaceutical product, for example where it is desired to impart properties provided by the edible fibers, e.g. taste or texture, such as described above.

Edible fibers of the invention may be cut to a desired length and dispersed in an organic or aqueous solution, for example a liquid-based matrix. The presence of the edible fibers in the liquid-based matrix may provide an increased in its viscosity. Variations in fiber aspect ratio, shape, rigidity, surface microstructure and concentration may be used to alter the rheological properties of the solutions in which the fibers are dispersed, for example enabling modification of the perceived texture of the suspension. The presence of single or multiple nutrients contained in edible fibers of the invention may be used to affect the taste and nutritive properties of the final suspension.

In one aspect, the invention provides an edible fiber as described above dispersed in a liquid hydrophobic matrix, for example a lipid-based or chocolate-based matrix.

In one aspect, the invention provides an edible fiber as described above dispersed in a liquid hydrophilic matrix, for example a dairy and/or non-dairy based beverage, a coup, a sauce or dressing.

Those skilled in the art will understand that they can freely combine all features of the present invention disclosed herein. In particular, features described for the product of the present invention may be combined with the process of the present invention and vice versa. Furthermore, features described for different embodiments of the present invention may be combined. Where known equivalents exist to specific features, such equivalents are incorporated as if specifically referred to in this specification. Further advantages and features of the present invention are apparent from the Figures and non-limiting Examples.

### EXAMPLES

### Example 1

### Materials

3 types of gelatin characterised by increasing Bloom values were used:
Gelatin crystal, extra pure, 160 Bloom;

### Gelatin (Bovine), 240 Bloom;

### Gelatin (Pigskin), 280 Bloom.

Gelatin was plasticised with glycerol, ReagentPlus® 99%, purchased from Sigma-Aldrich and the mixtures were solubilised in milli-Q water.

### Sample Preparation

Gelatin, glycerol and water were combined in the ratio 1:1:5 weight % (initial water content=71.4%). The mixture was heated at 80° C. and stirred for around 1.5 h. After this time a clear and homogeneous solution was obtained, that was degassed for 1 h at 80° C. and 50 mbar and consequently cast and dried at 65° C. for between 4 and 48 h. After drying samples were stored in a desiccator and tested within 24 h.

Rheological measurements were performed on a TA Instrument AR 2000ex (USA) rheometer. Oscillatory temperature ramps were applied to all samples, using heating ramps of 2° C. min⁻¹, 0.5% strain and 1 Hz frequency. Tests were performed in plate-plate mode, using a Peltier Plate heating system and 25 mm aluminum plates.

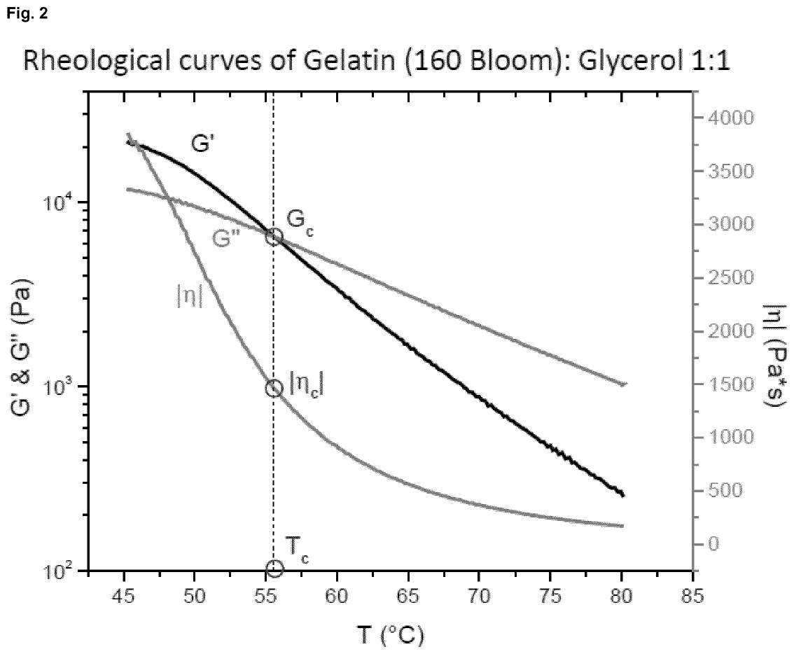

FIG. 2 reports an example of the rheological curve obtained for a Gelatin (160 Bloom): Glycerol 1:1 system dried for 18 h at 65° C. By increasing the temperature of the system a progressive change of the rheological properties, particularly a decrease in storage, loss modulus and complex viscosity is achieved. In particular, a transition point can be observed when the storage and loss modulus curves intersect: for temperatures below this point an elastic behaviour is prevalent in the material, while, above it, the loss modulus is preponderant, therefore flowing of the system can be observed.

Such transition can be imputed to the triple-helix to coil structure transition typical of gelatin gels. In terms of drawability of the system, this point represents the critical temperature above which thermal drawing could be achieved due to the capability of the material to flow. Therefore, the value of the modulus where G′=G″ may be referred to as “Critical Modulus G_{c}”, and, in the same way, the temperature and complex viscosity values corresponding to this point may be referred to respectively as “Critical Temperature T_{c}” and “Critical Complex Viscosity |η_{c}|”, as pointed out in FIG. 2.

The influence of glycerol content on the critical rheological parameters was investigated. Gelatin 160 Bloom was used and Gelatin:Glycerol weight ratios 1:0.5 and 1:0.75 were considered. The same sample preparation procedure was followed and samples were dried for 18 hours (water content as measured by weight loss ≈1%).

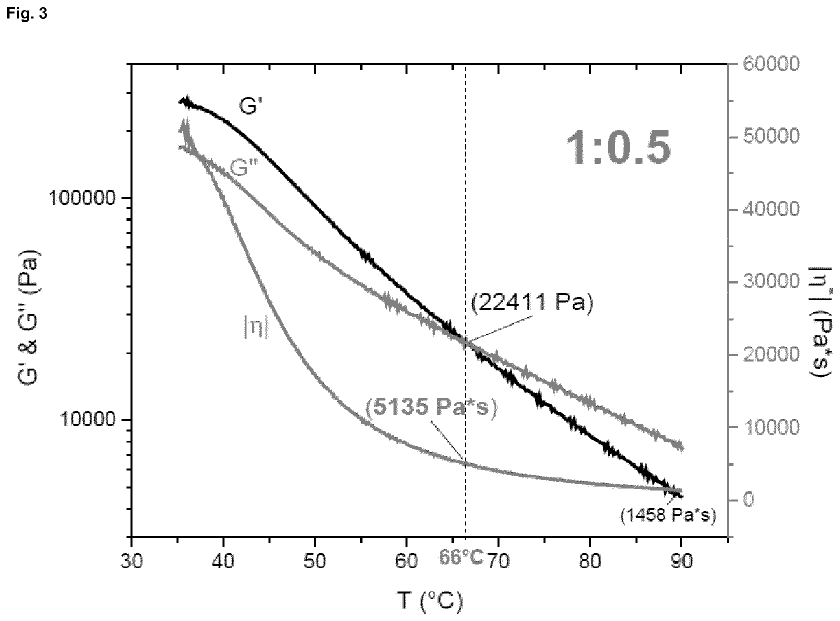

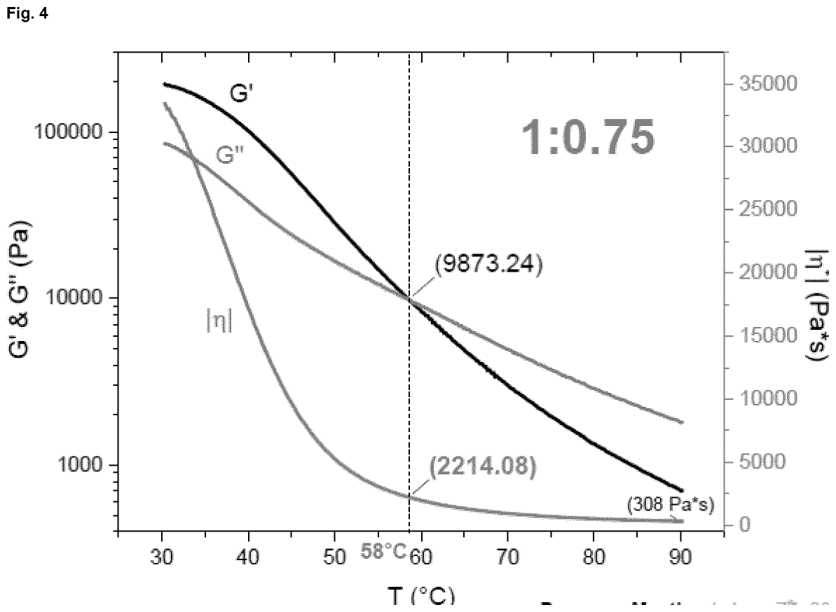

FIGS. 3 and 4 show the rheological curves obtained for the two samples.

### Preform Fabrication and Thermal Drawing

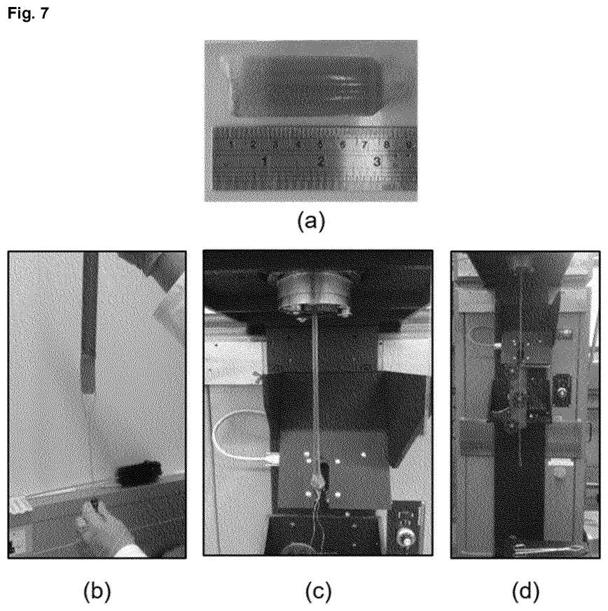

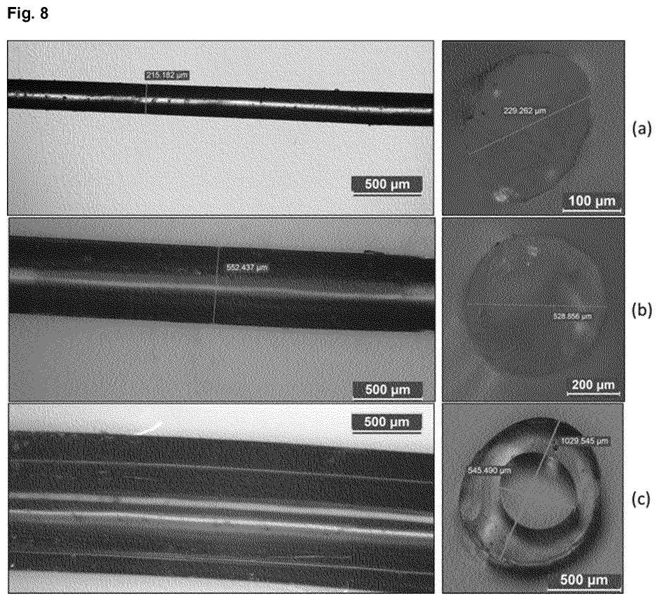

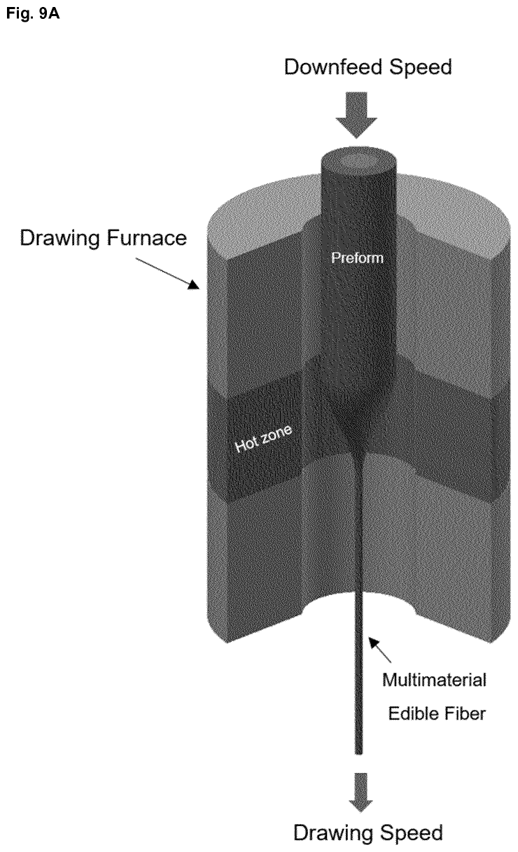

The formulation Gelatin (280 Bloom):Glycerol 1:1 with low water content (≈0% as measured by weight loss) was selected for the fabrication of a preform. After solubilising the gelatin, the obtained solution was poured into several Falcon tubes® and dried at 65° C. for approximately 15 days. The obtained preform (FIG. 7(a)) was subjected to thermal drawing. The drawing process was carried out using a furnace temperature of 100° C. (FIG. 7 (b to d)).

Hollow core preforms were also produced (both with circular and rectangular cross-sections) FIGS. 7 ((c) and (d)). For the fabrication of circular cross-section hollow-core preform a circular mold equipped of a metal bar positioned in the centre was filled with gelatin films cut in form of “pellets”. The mold was positioned in a vacuum, closed by a piston on which some weight (≈100 kPa) was applied. The system was heated to 80° C. under vacuum for around 12 h.

Rectangular cross-section hollow core preform were fabricated through a four steps hot-press process, where first the two half of the preform were hot-pressed, consequently an aluminum bar covered with Teflon® tape (final diameter≈5 mm) was hot-pressed together to one of the two halves of the preform embedded in it, and finally the two halves of the preform were merged together with a final hot-pressing step. The aluminum bar was then removed allowing to obtained a hollow-core preform.

Thermal drawing of solid core as well as hollow-core preform was carried out and fibers maintaining the original preform structure were obtained.

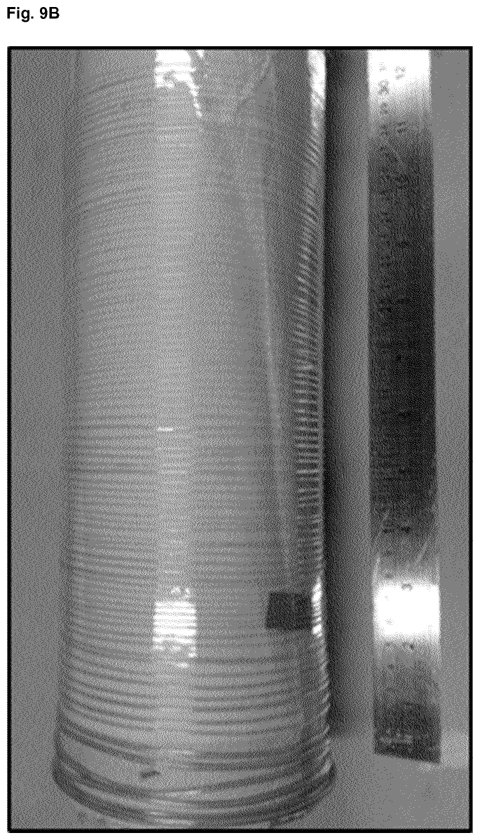

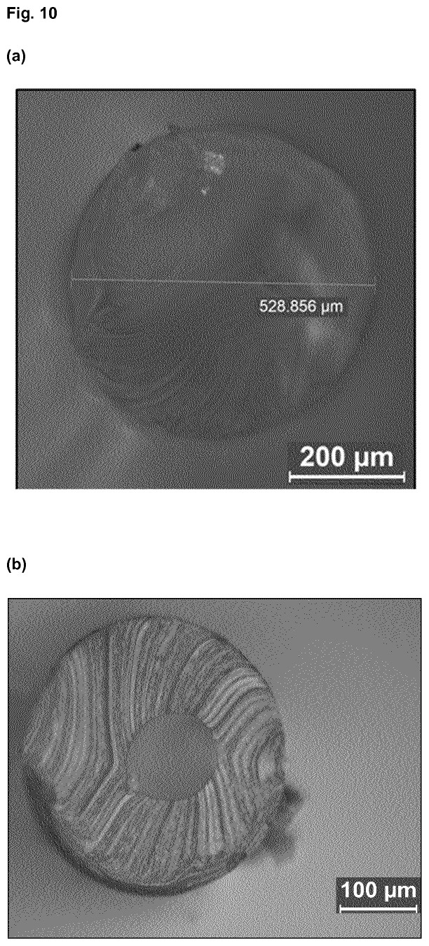

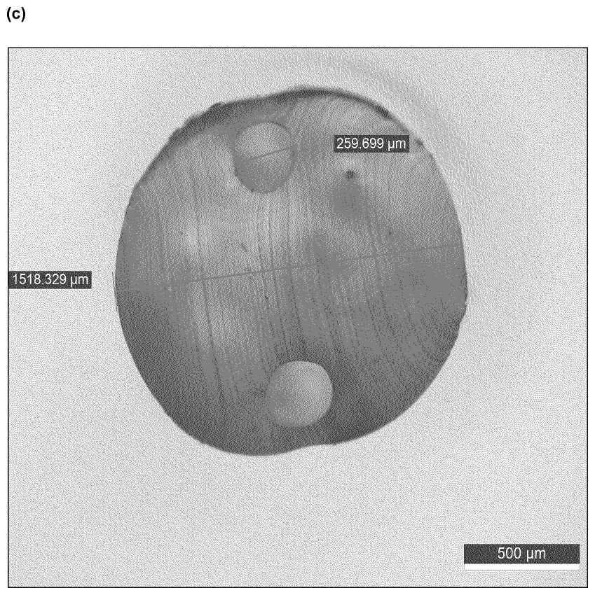

A result is presented in the picture of FIG. 9B, where around 20 meters of gelatin fibers were obtained (approximately 180° C. as middle temperature of the drawing tower). The thermal drawing process was carried out on a hollow-core rectangular cross section preform and fibers of decreasing diameter down to around 200 μm were obtained. FIG. 8 presents optical microscope images of the obtained fibers at different fiber locations. FIG. 8 (c) shows a hollow core structure.

### Example 2

The following Example describes the preparation of three different preforms, labelled Case 1, Case 2 and Case 3.

Case 1—Water (20 ml) was added to gelatin (2 g) and glycerol (2 g) and the mixture heated to 80° C. with stirring until complete dissolution. The warm mixture was then degassed for 1 h at cast 80° C. and dried (65° C.) overnight.

Case 2—Gelatin (2 g) and glycerol (2 g) were mixed in the absence of water and heated for 3 h at 60° C. to allow gelatin swelling.

Case 3—Water (20 ml) was added to casein (2 g) with stirring. Sodium hydroxide (1 M in water) was added dropwise to the solution until pH 7 was achieved. The suspension was then stirred for a further 30 min during which pH was periodically checked and adjusted with sodium hydroxide as required to maintain pH 7. After 30 min, glycerol (1 g) was added to the mixture. The mixture was then heated to 70-90° C. until complete dissolution. The warm solution was then cast and allowed to dry at room temperature overnight.

### Formation of the Single Material Preform

Following drying of the cast material (Case 1 and Case 3), or gelatin swelling completely absorbing the glycerol (Case 2), the preform was assembled.

Assembly of the preform was directly as cast or through hot-pressing of the cast material. Hot-pressing was performed for 30 min under vacuum at temperatures of 70-120° C. and pressures of 20-40 N/cm³.

### Thermal Drawing

Prior to thermal drawing, preforms were conditioned in a degassing oven or in a chamber with controlled relative humidity at room temperature for at least 48 h (until the sample mass remained constant). Preforms were attached to a preform holder and introduced into the three-zone vertical tube furnace of the drawing tower. The tube furnace was initially at room temperature then progressively heated to the drawing temperature (middle zone at 150-220° C.).

Tens of meters of fibers with diameters down to few hundreds microns were drawn with the initial preform structure maintained. (FIG. 9B).

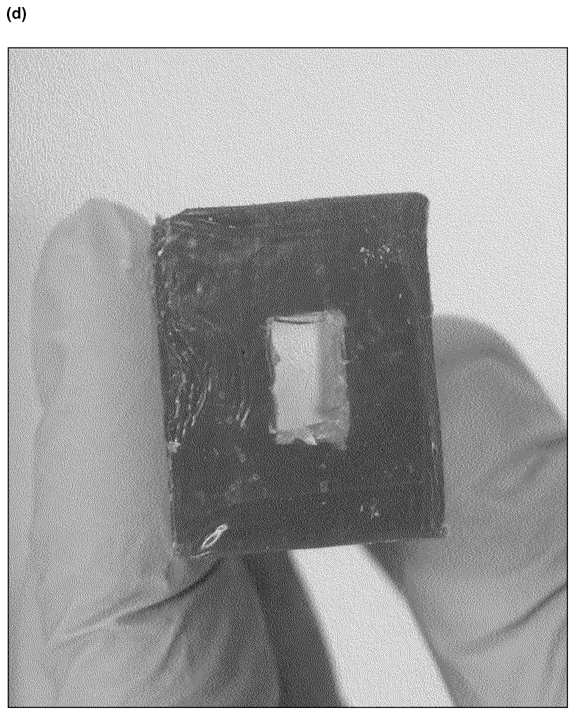

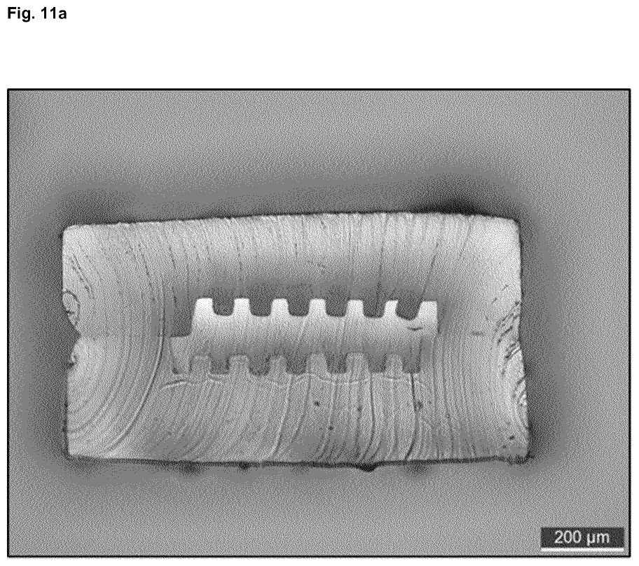

Fiber architectures are shown in FIG. 10(a)-(d).

### Example 3

As discussed above, the inventors believe that in order to obtain optimal thermal drawing, the materials used should satisfy the following rheological requirements: i) a transition from an elastically dominated domain to a viscous dominated one, characterised by a G′-G″ cross-over in a shear viscosity measurement where G′ drops more rapidly with temperature than G″; ii) the complex viscosity values 1-30° C. above such cross-over are greater than 10³ Pa*s.

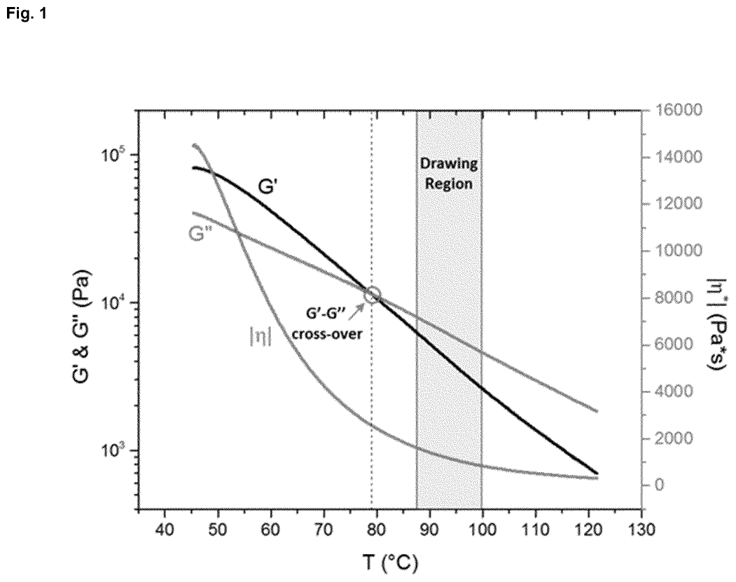

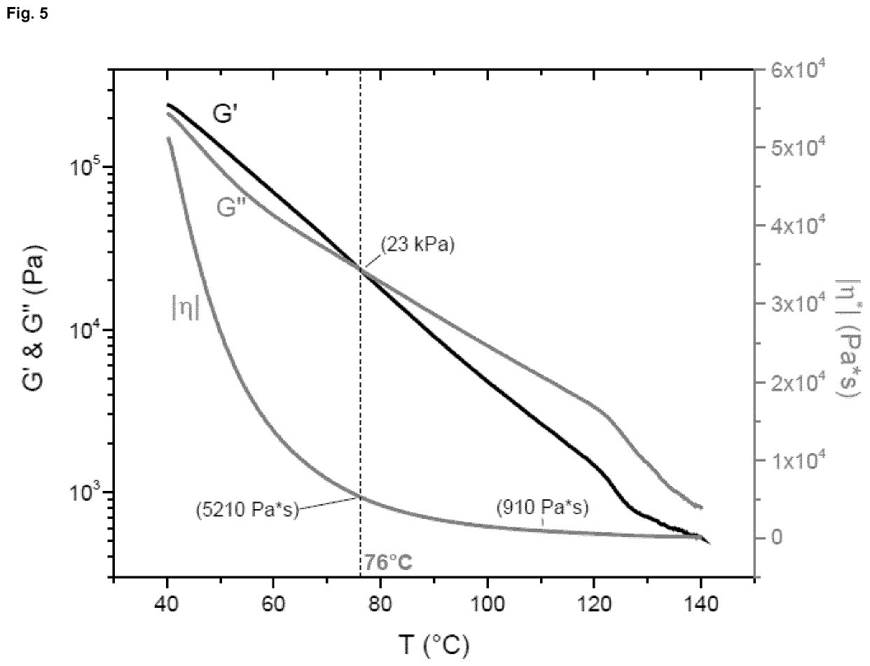

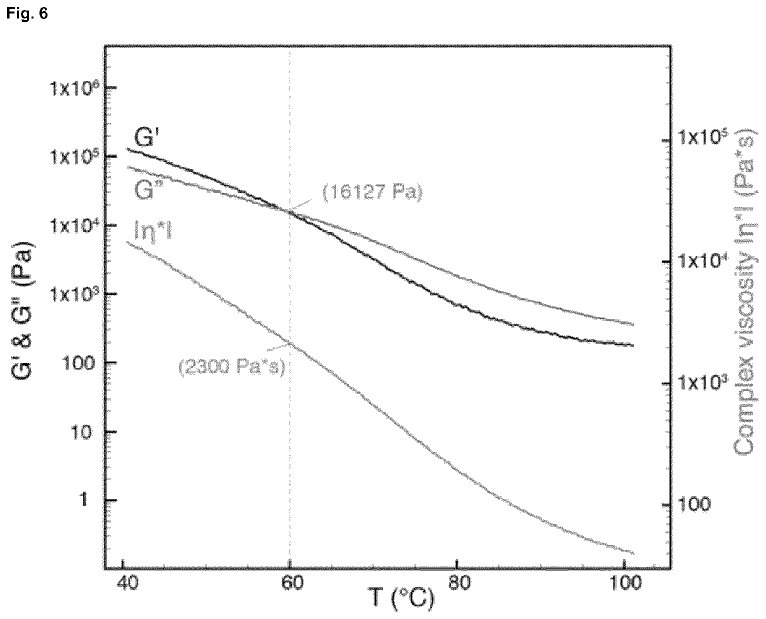

The following preform compositions have been prepared and characterised, and have a G′-G″ cross-over point and favourable drawing characteristics, where the ratio listed is the biopolymer:plasticiser weight ratio:
Gelatin (280 Bloom): Glycerol 1:1 (FIG. 1)
Gelatin (160 Bloom): Glycerol 1:1 (FIG. 2)
Gelatin (160 Bloom): Glycerol 1:0.5 (FIG. 3)
Gelatin (160 Bloom): Glycerol 1:0.75 (FIG. 4)
Gelatin (280 Bloom): D-Sorbitol 1:1 (FIG. 5)
Casein: glycerol 2:1 (FIG. 6)

1. An edible fiber comprising a biopolymer and a plasticiser:
wherein the weight ratio of biopolymer to plasticiser is about 1:0.25 to about 1:3; and
wherein the fiber has a diameter of about 0.5 μm to about 1 mm.

2. The edible fiber of claim 1, wherein the fiber has an aspect ratio of at least about 10.

3. The edible fiber of claim 1, wherein the biopolymer comprises a protein and/or a polysaccharide.

4. The edible fiber of claim 1, wherein the biopolymer is selected from the group consisting of gelatin, casein, egg white albumin, soy protein, whey protein, wheat gluten, pea protein, sorghum kafirin, and millet prolamin.

5. The edible fiber of claim 1, wherein the biopolymer is selected from the group consisting of pectin, alginate, and agar.

6. The edible fiber of claim 1, wherein the plasticiser comprises a polyol.

7. The edible fiber of claim 6, wherein the polyol is selected from the group consisting of glycerol, sorbitol, glucose, sucrose, maltitol, xylitol, erythritol, and isomalt.

8. The edible fiber of claim 1, wherein the fiber comprises at least one hollow channel.

9. A process for producing an edible fiber, the process comprising the steps of:
(a) combining a biopolymer and a plasticiser in a weight ratio of biopolymer to plasticiser of about 1:0.25 to about 1:3 to produce a preform; and
(b) subjecting the preform to thermal drawing to produce an edible fiber.

10. (canceled)

11. The process of claim 9, wherein thermal drawing is carried out at a drawing temperature of about 30° C. to about 300° C.

12-13. (canceled)

14. A food, cosmetic, pharmaceutical, veterinary, animal feed or nutraceutical product comprising an edible fiber comprising a biopolymer and a plasticiser:
wherein the weight ratio of biopolymer to plasticiser is about 1:0.25 to about 1:3; and
wherein the fiber has a diameter of about 0.5 μm to about 1 mm.

15. (canceled)
